(19) United States
(12) Patent Application Publication
(10) Pub. No.: US 2008/0107261 A1
(43) Pub. Date: May 8, 2008

(54) Method for Protecting Confidential Data

(76) Inventor: Stefan Kistner, Troisdorf (DE)

Correspondence Address: K.F. ROSS P.C., 5683 RIVERDALE AVENUE, SUITE 203 BOX 900, BRONX, NY, 10471-0900, US

(21) Appl. No.: 10/589,476

(22) PCT Filed: Feb. 22, 2005
(86) PCT No.: PCT/EP05/01817

§ 371 Date: Jun. 20, 2007

(30) Foreign Application Priority Data
Feb. 23, 2004 (DE) 10 2004 009 065.3

(51) Int. Cl. H04L 9/00

(52) U.S. Cl. 380/29

(57) ABSTRACT

The invention concerns a method for preventing the loss of confidentiality of data electronically stored in the computer system comprising the following steps: analyzing the protocol and the data flow from and to data carriers and/or peripheral devices; forming a classification, particularly for differentiating between non-exchangeable and exchangeable data carriers; determining, according to the encountered classification, whether an encryption of the electronically stored data is required for preventing the loss of confidentiality of the data and, according to this determination; optionally supplementing the file system on an exchangeable data carrier with a cryptographic encryption and/or carrying out a cryptographic encryption of all or several of the blocks of the exchangeable data carrier.

The invention relates to a method of preventing the loss of confidentiality of data that is electronically stored in a computer system, the data being organized in particular by means of a file system and/or a division of blocks being established, in particular when removable and/or exchangeable data carriers and/or storage media are used, wherein in particular peripheral devices can be connected to the computer system.

More and more desktop computers have interfaces by means of which an uncontrolled and generally unwanted exchange of data can be effected by means of removable and/or exchangeable data carriers and/or storage media. The deactivation of these interfaces is not practical, since they are necessary for the connection of peripheral devices, such as for example the USB port.

Transport and storage of exchangeable data carriers and storage media require special security measures for preventing unauthorized reading and thus loss of confidentiality.

The application of cryptographic encryption methods for encrypting the data for preventing unauthorized reading of the data is known.

Here, a problem is the fact that in known desktop computers it is possible to connect storage media to computers without specific technical knowledge. Due to almost ubiquitous availability, the risk of abusive use increases more and more. There exist no administrative control mechanisms against this risk.

In particular the USB port present in modern computer systems is a danger, since so-called memory sticks that can be connected to USB ports only have a small size und are therefore not noticed easily, are easy to handle and are directly recognized in modern operating systems even with the computer already turned on. Such storage media thus make possible an abusive use in an easy manner, i.e. in particular, the theft of electronically stored data.

From WO 2002/019592 A2, a method is known in which each file that is to be stored on a storage medium such as floppy disk. or CD-ROM is encrypted block by block in a UNIX-based system and an encrypted file that is to be read is automatically decrypted block by block.

Here a disadvantage is the fact that in the case of a general encryption, any time a storage process is carried out, a desired data transfer, for example for publications, is prevented. Furthermore, a disadvantage of this method is the fact that no difference depending on the danger of data loss in different data carriers can be made.

The object of the invention is therefore to provide a solution for these disadvantages as well as to provide a method that prevents an unwanted data transfer by means of exchangeable storage media while maintaining the functionality of the interfaces without limiting the desired data transfer by means of exchangeable storage media.

This object is attained according to the invention in that in a method of preventing the loss of confidentiality of electronically stored data in a computer system, which data in particular is organized as a data system and or subdivided into blocks, in particular with use of exchangeable and/or removable data carriers and/or storage medium, where in particular peripherals are connectable to the computer system, the following steps are carried out:

analysis of the protocol and of the data stream from and to data carriers and/or storage media and/or peripheral devices;

establishment of a classification, in particular for differentiation between nonremovable and removable data carriers and/or storage media;

determination according to the established classification whether an encryption of the electronically stored data is required for preventing the loss of confidentiality of the data and according on this determination possibly

adding a cryptographic encryption to the data system on a removable data carrier and/or a removable storage medium and/or performing a cryptographic encryption of all or several blocks of the removable data carrier and/or of the removable storage medium.

By means of the method according to the invention, it is therefore possible in a particularly advantageous manner to reliably prevent the loss of confidentiality of the data that is electronically stored in a computer system and thus to permit the highest possible degree of flexibility, since while the functionality of the interfaces is maintained, the unwanted data transfer by means of exchangeable data carriers and/or storage media is prevented, the desired data transfer not being limited. Here it is particularly advantageous that according to the method, a classification of the data carriers or the storage medium is carried out and that it is in particular possible to differentiate between different types of data carriers and/or storage media.

Further advantageous designs of the method according to the invention are given in the dependent claims.

A program that is embedded in the operating system, generally consisting of several drivers, filters, services, etc. analyzes the protocol and the data stream from and to data carriers, storage media and peripheral devices. As a function of the properties and preferences that have been predetermined or administratively declared, an automatic classification is carried out that determines the possibility of using as exchangeable storage medium or as exchangeable data carrier for thus determining whether the danger of loss of confidentiality of the data exists and for carrying out an encryption of the data if necessary.

In particular, all data carriers or devices that can be used as exchangeable storage media can be provided with encryption. It is possible either to encrypt the entire data carrier or alternatively, only file contents or parts of files or selected files.

The data carrier or storage medium as referred to in this method is in particular any nonvolatile storage that is readable by computer systems or that is readable and writable. It can be connected permanently to the computer or can be removable and/or it can be provided with exchangeable media, such as for example floppy disks, ZIP drives, Jaz, tapes, CD, MO, WORM, etc.

The organization of nonvolatile data carriers is carried out typically in blocks or sectors. The blocks in most data carriers are of constant size; in particular of the size 2ⁿ wherein n is greater than 8. Nevertheless, they can also be of variable size, as for example in streaming data. The physical realization, i.e. electric, magnetic, optical, etc. and the division of the blocks on the data carrier is not important for the application of the method according to the invention. Here the smallest readable or writable unit is formed by blocks.

The abstraction of a partition or of a data carrier that is not to be partitioned is a volume. This is the entity of the blocks that are organized by means of the file system. One or more data carriers or partitions can be included. Each volume has a whole number of blocks. A volume is accessed by a mounting process and is available within the computer system until the dismounting process. When, for example, memory sticks are used that are connected to the USB connections, the mounting process is carried out automatically, since modern operating systems of computer systems are able to directly recognize such peripheral devices.

Data stored on volumes, i.e. in particular in partitions or in an entire data carrier, are organized by a file system. This file system organizes the files as well as meta-information concerning the files that is required for locating the data on the data carrier. The data itself is organized in files. The meta-information is stored in directories and possibly further files that in general cannot be accessed. A plurality of file systems having further specific properties is known. Any file system shows the logical organization of a data carrier in a specific manner on the basic block structure of the data carrier.

Operating systems differentiate between at least two hierarchical levels in which software is run. In the (privileged) kernel mode, all machine commands can be performed, i.e. it is possible to access system data and hardware practically without any limitation. The kernel of the operating system that is operated in this mode abstracts and virtualizes the hardware and provides services for the part of the operating system that is run in the User Mode. The part works in a processor mode that is not (or less) privileged, that is, only a limited set of machine commands is available. It is generally not possible to access system data and hardware. Applications and protected subsystems are run in the User Mode.

The present method can complement the modular structure of today's operating systems. It cooperates with the operating system and extends it. Therefore, no parts of the operating system have to be replaced or modified. Only the operating method of file system drivers is modified by changing the binary representation of the data on the data carrier.

The method can in particular be used for all operating systems working with data carriers that have a block structure.

All data carriers or devices that can be used as exchangeable storage media can be provided with an encryption dependent on the established classification. Here it is possible to either encrypt the entire data carrier or only certain file contents.

The method according to the invention permits the use of exchangeable storage media without the risk of them being compromised by unauthorized persons. This does not only apply to semiconductor storage media such as exchangeable hard disks, memory stick, etc, but also for all magnetic, magneto-optical or optical data carriers such as for example floppy disks, ZIP drives, Jaz, tapes, CD, MO, WORM, etc. It is not necessary to turn off or to uninstall interfaces or drives. Thus, the full functionality of the computer hardware can be used.

The method according to the invention is applied at a very low level almost directly upstream of the data carrier, such that the method according to the invention is noticed neither on application programs nor on the operating system. In particular, there is not necessarily a coupling of user authorization and key management. Thus, the security of the storage medium is independent from the security of the operating system, that is, unsafe, spied-out or noted passwords do not reduce the security.

No action of the user is required that could be omitted due to negligence or bad faith.

No modifications of the logic of the operating system or a special file system, such as for example EFS Encrypting File System is required. The specific advantages of the file system are fully maintained, since the file system itself is not affected. The protection is not limited to a particular file system but complements any file system.

In the case of loss or theft of data carriers, this does not means the loss of confidentiality of the data contained thereon, since the data stored on the carrier are encrypted entirely or at least partially. The cryptographic method that is applied is unknown to a possible attacker, which makes a possible attack more difficult.

Thus, a possibly unsafe storage medium is changed into a storage medium for particular security requirements by application of a method according to the invention, since particularly sensitive data can exclusively be stored on exchangeable storage media for thus being protected due to physical locking against unauthorized access.

By application of the method according to the invention to several computers by using a common key, a security domain is formed. Here no connection of the computers belonging to the same security domain is required, such as for example in a network (LAN; WAN). Within a security domain, the encryption is suspended for the other computers within the security domain, so that exchangeable storage media, for example for securing data, can be used without limitations. The means for access control provided by the operating system are maintained.

Preferably, it can be determined that an encryption of all blocks of the data carrier/storage media or that an encryption of all files before storage on the data carrier/storage medium and that an encryption of several files before the storage on the data carrier/storage medium is carried out.

This way, it is advantageously possible to create a security and compatibility hierarchy having several levels, in which a classification can established as a function of the data to be stored.

When all blocks of a data carrier are encrypted, the entire volume, i.e. all sectors, is encrypted. The data carrier is shown as randomized on the computer system without the method according to the invention, i.e. unformatted and therefore not readable. This strategy offers maximum security while minimum compatibility is required.

Alternatively, an encryption of all files of the volume, i.e. of all files of a partition or of a data carrier can be carried out. The data carrier or the volume thus is shown as intact on computer systems without the method according to the invention, the data itself being randomized, that is it cannot be read. An attempt at accessing the data leads to error messages and is unsuccessful. Only the file names can provide a certain indication of the content that however is hidden.

Alternatively, an encryption of several selected files of a volume can be carried out. Newly created or overwritten files or files adhering to definable criteria are encrypted. Such criteria can in particular be the file type and the storage location. Files that already exist will remain unmodified. In particular, existing files can be provided with write protection that cannot be suspended, so that modifications thereto are excluded. An advantage in this strategy is in particular high security with maximum compatibility with respect to computers or devices without the method according to the invention. For examples, digital cameras generate unencrypted files on a volume, in this case, the camera memory, that can be read. All file accesses however are carried out under encryption.

In particular, when several selected files are encrypted before storage on the data carrier/storage medium, it is possible to maintain the meta-data or the communication as a whole but to protect the data itself against access.

Alternatively or additionally, it is also possible for each file system to be complemented by a cryptographic encryption on nonexchangeable and/or nonremovable data carrier and/or storage media. This way, maximum security can be achieved.

In a preferred embodiment, the cryptographic encryption is temporarily suspended when particular features are shown. This can in particular be achieved by the fact that hardware having an integrated key such as for example a dongle and/or by using of a keyword and/or by recognizing and checking biometric data of a user, an encryption of data can be suspended for enabling for example a desired publication of data.

When a data carrier and/or a storage medium are used without a file system, an encryption of all blocks can be carried out.

When a data carrier and/or a storage medium is connected to a multifunctional interface and/or a multifunctional bus, in particular a slot, USB port, and the like, the functionality of the interfaces and/or the buses is maintained and encryption is only performed on the data streams that are further transmitted to the interface and/or the bus for storing the data. Recognition of these data streams is assured by means of the method according to the invention, since an analysis of the data stream from and to data carriers and/or storage media and/or peripheral devices is carried out. Thus, it can be assured that on the one hand the full functionality of the interface or the bus is maintained, as it is for example required, when a printer is connected to a USB port, and on the other hand, in the case of data to be stored, such as when a memory stick is connected to a USB port, at least a partially automatic encryption for preventing the loss of confidentiality of data is carried out.

Preferably, an analysis of the interface and/or of the bus to which the data stream shall be transmitted is carried out, this analysis being taken into account for the establishment of the classification, in particular with respect to definable criteria, in particular with respect to the physical connection and/or further properties such as for example with or without cable and/or properties of the device or internal and/or external and/or permanent or exchangeable, that is that for example printer and memory sticks that can both be connected via a USB port to the computer system, can be classified differently regarding the danger of loss of data.

Preferably, cryptographic methods are used for the encryption; in particular the Rijndael algorithm offers high security against unauthorized decryption.

During a process of reading from an at least partially encrypted data carrier and/or storage medium, the decryption of, data advantageously is carried out automatically. It is advantageous if during access to a data carrier and/or storage medium, it is determined whether an encryption of all blocks of the data carrier/storage medium or an encryption of all files on the data carrier/storage medium or an encryption of several files is present, and whether an encryption of the requested data performed.

For encryption or decryption, keys can be used that are formed by combination of different parts, in particular several computer systems being combined in groups, the key of a group of computer systems having a corresponding part as well as a respective individual part.

In particular, forming keys by combining different parts of variable or determined bit length is possible. By means of a key management comparable to a master key system, security domains can be organized. Furthermore, the formation of key sets as subkeys of a security domain is possible, intersections be able to be formed such that a data exchange, that is the decryption of encrypted data within a group, can be permitted, prevented or partially prevented.

On the one hand, the key can be embedded in the method according to the invention, that is can be permanently encrypted. The key however can also be stored in a data base or can be embedded in hardware, for example in a dongle or by using an algorithm that is generated from biometric data of a user.

An implementation of the method according to the invention can be carried out such that a combination of suitable filters and drivers can be formed that analyzes and, if necessary, modifies on a very low level the protocol and data streams between the application programs on the one hand and higher levels of the operating system and of the storage media on the other hand.

The modification consists in the application of a cryptographic encryption. It can either encrypt the entire storage medium or parts of it (file contents) (according to the installed option). In the encryption of parts (file contents), in particular also meta-data can be manipulated. The selection of the interfaces and drives to be controlled can be determined with respect to the products or can be determined and subsequently organized.

A further module serves as key administrator for the cryptographic component. It can organize the necessary keys in a suitable file or a data base for individual computers. For several computers with common key management, this service makes available the keys either from local organization or within a connection—for example in the LAN—in accordance with a central key manager.

When particular features are shown, the encryption can be suspended temporarily. These features can be present due to a particular identification, for example of a physical key; they can nevertheless also be based on the data.

Thus, a so called dongle, which is only used temporarily, can suspend the encryption and make it possible to generate data carriers for publication. In the same manner, the recognition of particular file formats can suspend the encryption, such that image data can be read by a camera.

An illustrated embodiment of the invention is represented in the figures and will be further described in the following. Therein:

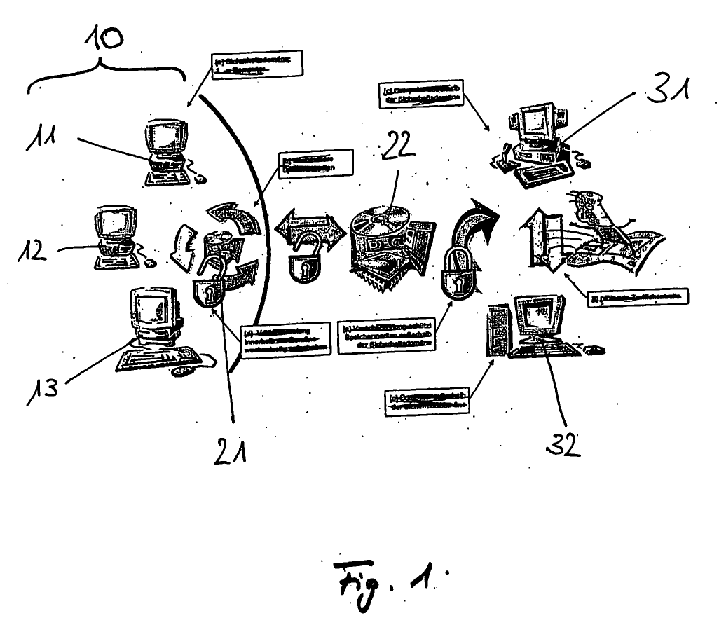

FIG. 1 shows a diagrammatic representation of the application of the method in several computer systems or computers.

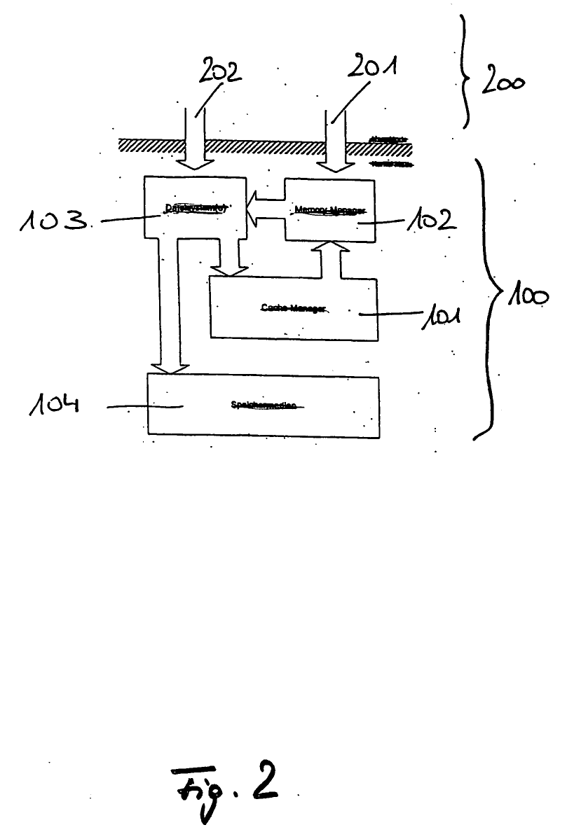

FIG. 2 shows the reading and writing process of data on computer systems according to the state of the art.

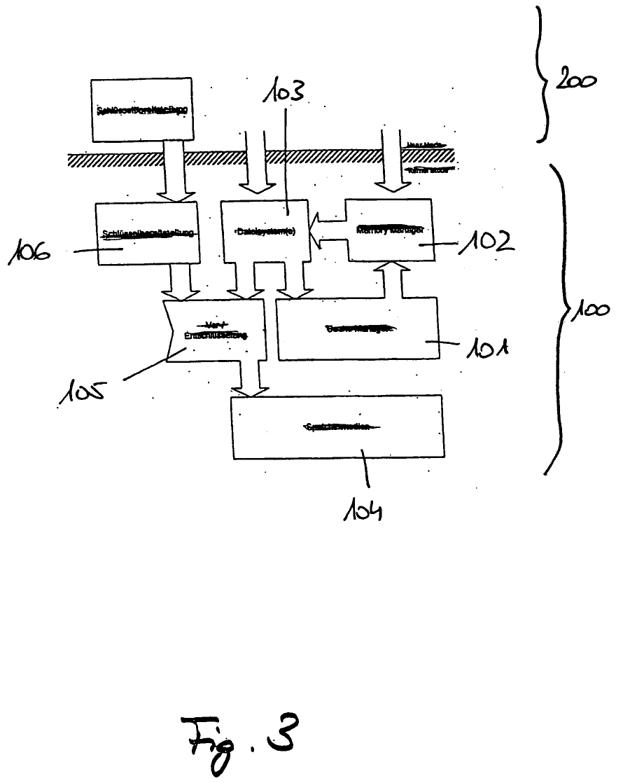

FIG. 3 shows the reading and writing process of data on computer systems according to an illustrated embodiment of the method according to the invention.

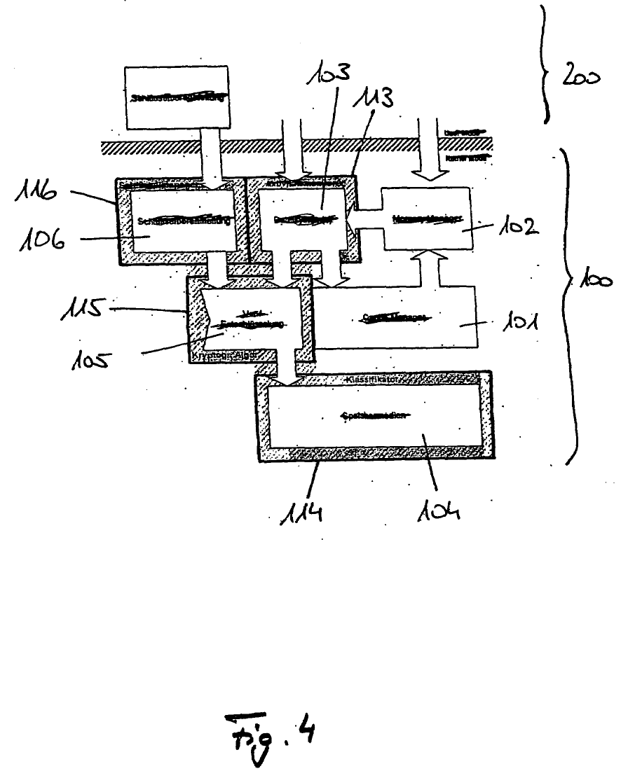

FIG. 4 shows a diagrammatic representation of the method according to FIG. 3 with further components.

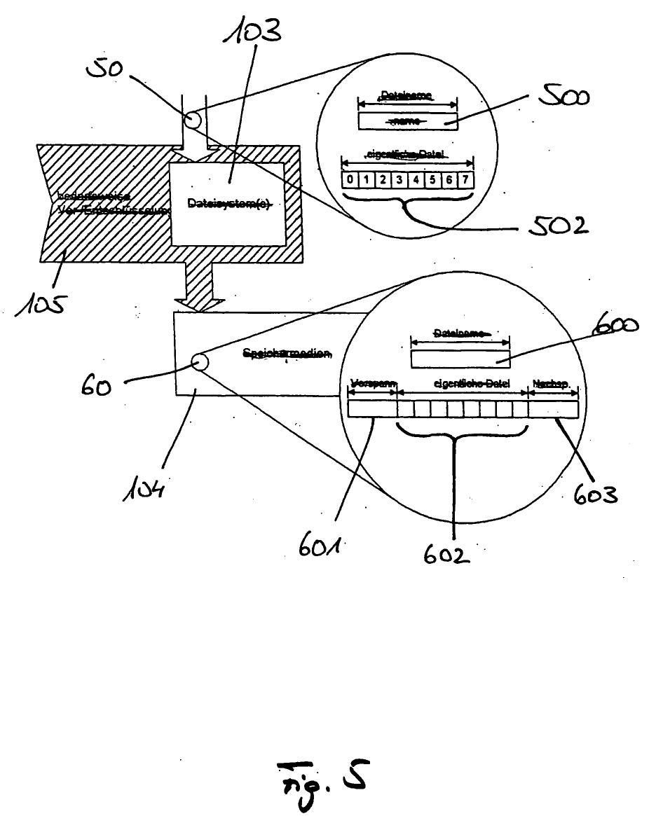

FIG. 5 shows the representation of a data carrier or a storage medium in reality and as it can be seen from accessing programs.

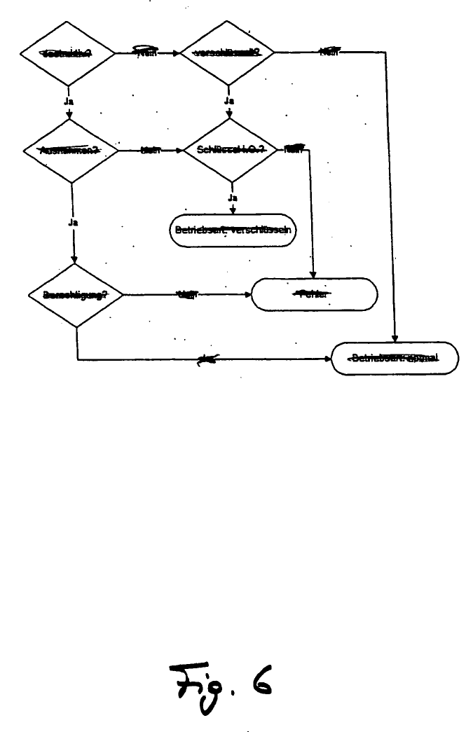

FIG. 6 shows the process of opening or creating a file

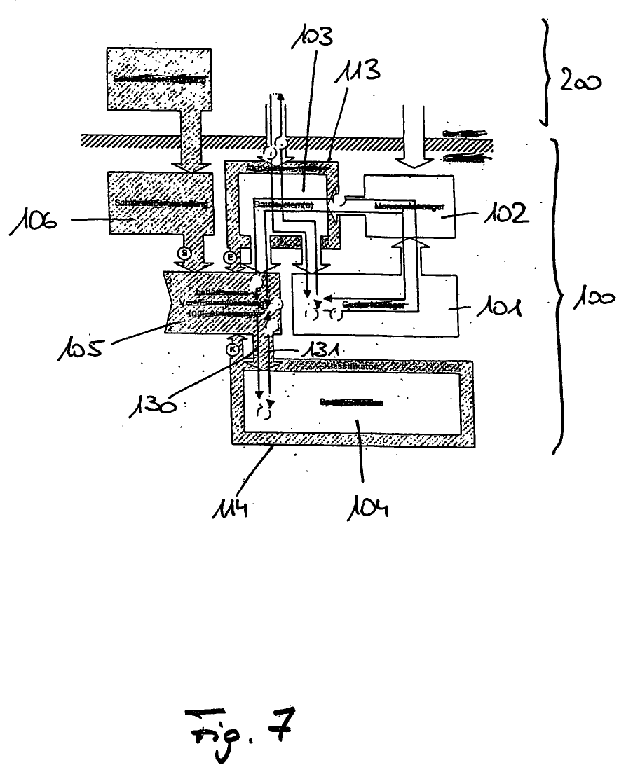

FIG. 7 shows the data stream in reading and writing a file with the method according to the invention as well as according to the state of the art.

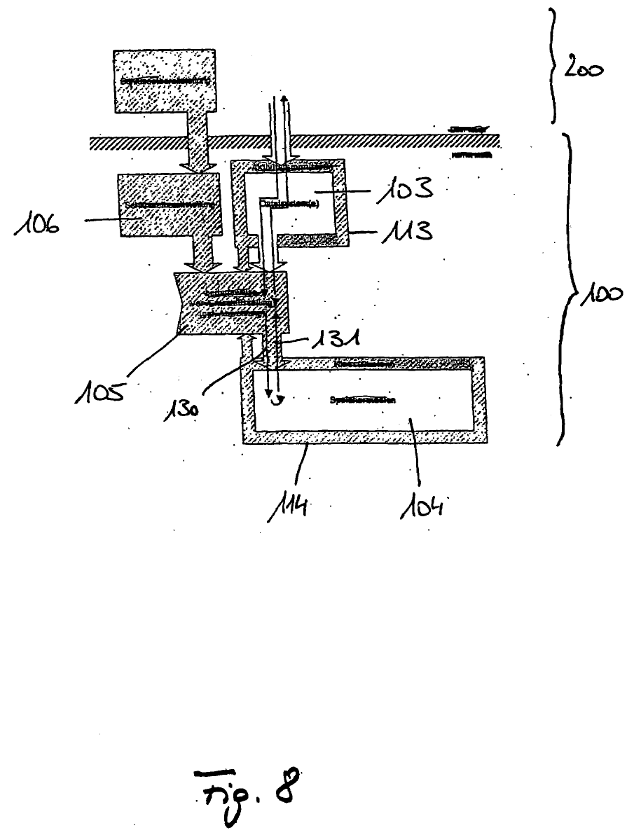

FIG. 8 shows the data stream according to FIG. 7, where however a system cache is avoided.

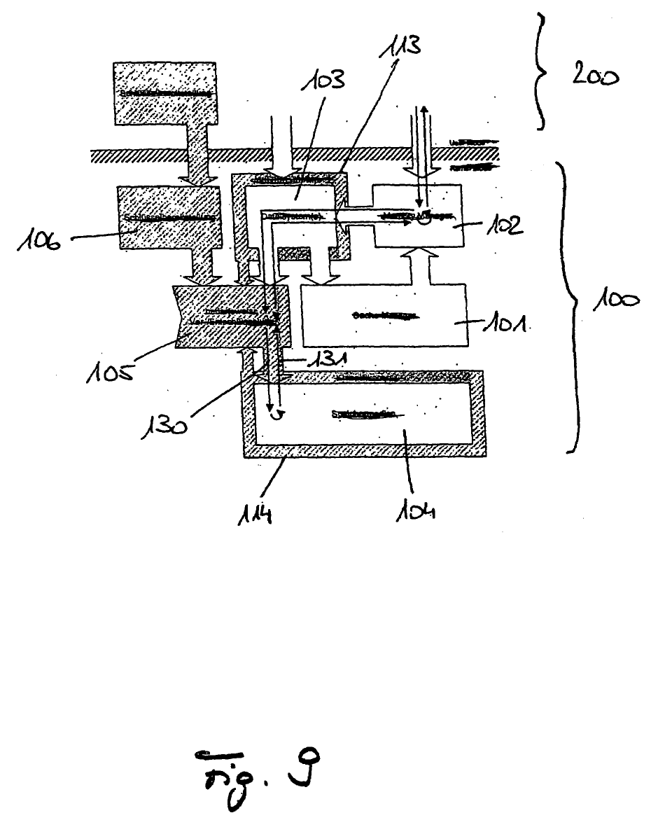

FIG. 9 shows a data stream during reading and writing by means of MMF (Memory Mapped Files).

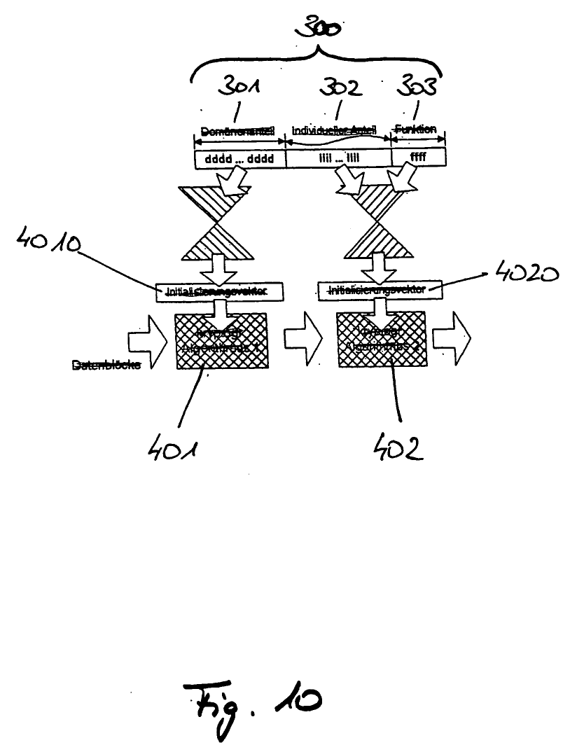

FIG. 10 is a diagrammatic representation of an encryption process.

FIG. 1 is a diagrammatic representation of the application of the method in several computer systems or computers. By connecting several computers 11, 12, 13 together that have a common key management, a security domain 10 is formed. Here it is not required that all computers 11, 12, 13 be connected to one another. Thus, one or more departments of a company can form a security domain 10. Also, these can be several computers of a user at different locations between which data is transmitted via removable data carriers.

Exchangeable storage media 22 that are formed within the domain 10 or individual files thereon that are written within the domain 10 cannot be read from computers 31, 32 and vice versa. Within the domain 10, exchangeable storage media 21 can be used without limitations.

In particular, the following scenarios are possible in the application of the method:

Tape cartridges or other storage media that are used for protecting data can be stored in a distributed system. Special measures for securing data during transports are no longer necessary.

Particularly sensitive data can be stored exclusively on exchangeable hard disks. They can be physically locked and can only be read within the security domains.

Legal restraints concerning data protection can be observed more optimally, since all storage media that leave the security domain or that are exchanged between subordinated subdomains are protected against unauthorized reading.

Personal or economic disadvantages can be avoided for the same reasons.

In a LAN, local data backups (on client computers) can be carried out. Abusive use thereof is excluded.

Uncontrolled running of unreleased programs can be suspended, since writing via storage media is not possible (as far as for example CD-ROMs are not released).

FIG. 2 diagrammatically shows the process of reading and writing data in computer systems according to the state of the art. Operating systems therein differentiate between at least two hierarchy levels in which software run. These hierarchy levels are the kernel mode 100 on the one hand as well as the user mode 200 on the other hand. In the user mode 200, in particular application programs are provided and being run.

In the kernel mode, the data that is electronically buffered in the cache 101 are transferred via a memory manager 102 by means of a file system 103 to the storage media 104 and are stored on these storage media 104. The request for running this process is carried out by application programs that are run in the user mode 200. The respective requests of such application programs can be carried out by accesses according to arrow 201, by access to the memory manager 102 or as indicated by the arrow 202 by access to the file system 103. A reading process is carried out by opposite procedure, that is, by reading data from the storage medium 104 by means of the file system 103 and if necessary, forwarding the data to the cache manager 101 or the memory manager 102.

The data that is stored on the storage medium 104 is not protected against unauthorized access. In case the storage medium 104 is an exchangeable storage medium such as for example floppy disks or CD, a loss of the confidentiality of the data cannot be excluded.

FIG. 3 shows the reading and writing process of data on computer systems according to an example of embodiment of the method according to the invention.

On the kernel-mode hierarchical level, the communication connection between file system 103 and storage medium 104 is provided by an encryption 105. The encryption or decryption 105 is based on a key that is provided by a module 106. When a classification of the storage medium 104 to be addressed has been effected, an encryption or decryption of the data to be read or to be written by the encryption or decryption module 105 is effected.

The module for providing the keys 106 therein is embedded in the hierarchy level of the kernel mode 100. The module for providing the keys 106 can however receive user-defined and/or hardware-based keys, for example from the user mode 200 by using a dongle or by using biometric data of the user.

An implementation of the method according to the invention can be achieved by means of the components according to FIG. 4 that observe the communication of the modules within the operating system and modify it in a suitable manner. Preferably, it is effected according to FIG. 4 completely in the kernel mode 100. Thus, it is possible to achieve a complete, immediate integration in the operating system on the one hand and the protection of programs in the user mode 200 on the other hand.

The method according to the invention is such that the encryption or decryption 105 takes place directly before writing or after reading of blocks on or from the storage medium 104. The data that is possibly encrypted on the data carrier 104 are never encrypted in the principal storage. Thereby, even in the case of encryption algorithms that are processor-oriented, the impairment of the system performance is as low as possible.

It is particularly advantageous to perform the encryption and decryption during the time in which the system is waiting for the performance of a request to a data carrier 104 anyway.

Writing processes are carried out such that every block is encrypted as the preceding block is being written on the data carrier 104. This is similar to reading processes, where every block is being decrypted while the next block is being read. Here it is advantageous that in the case of a reference implementation even PCs with a CPU of 300 MHz do not show deceleration except of a slight latency that cannot be noticed. The fact that the method is performed is only noticed regarding the CPU load of 60%,instead of the no load-running during the I/O-holding time.

The method according to the invention permits further strategies concerning the scope of the encryption. There is the possibility of encrypting the entire data carrier, i.e. each block is encrypted or of the encryption of all files or the encryption of several files, as will be described in the following:

1. Encryption of the volumes in total.

All sectors are encrypted. The data carrier 104 is shown as randomized on computers without this method, i.e. unformatted. External data carriers 104 must be newly formatted before use or if maintaining the data is desired, the data has to be converted. For increasing security, the generation of the initializing vectors 4010, 4020 (FIG. 10) can be modified by means of the absolute block address (of the data carrier) known in this method. This strategy offers maximum security while minimum compatibility is required.

2. Encryption of all files of the volumes.

The data carrier 104 is shown as intact on computers without this method; the files themselves are shown as randomized. An attempt at accessing the data leads to error messages and is unsuccessful. Only the file names can provide a certain indication of their content. During establishment thereof, all files have to be encrypted.

3. Encryption of some files of a volume.

Newly created or overwritten files are encrypted. Files that already exist are not modified. They are provided with a write protection that cannot be suspended and that is comparable to files on CD-ROM, such that modifications thereon are excluded.

This is the strategy that is most advantageous. Security is sufficiently high when the cryptographic algorithm is properly selected and assures maximum compatibility with computers or devices without this method. For example, digital cameras generate unencrypted files on a volume, i.e. the camera memory, that can be read. All writing file accesses however are carried out in an encrypted manner.

In the last-mentioned mode of encryption of all files, a label regarding the encryption has to be applied to each file. Here this label has to be compatible to all file systems. By means of a random distribution of the name space for file names, this method enables the labeling of the files that have been created according to this method, i.e. the encrypted files with respect to the membership of their file name to one of the two name subspaces for the discrimination between “encrypted” or “unencrypted”.

The labeling can be effected as indicated in the following example:

| | Representation of the | File name |
|---|---|---|
| | file name in an | on the data |
| Action | application | carrier |
| File is being generated | xy.doc | |
| The method modifies the | | xy.doc.$~# |
| file name | | |
| Listing of the directory | xy.doc | |
| shows | | |
| Listing of the directory | | xy.doc.$~# |
| of a computer system | | |
| without the method shows | | |

By means of application of the method according to the invention, the modification of the files on a data carrier thus is not visible to the user, since the representation of the content of the data carrier according to the foregoing example does not indicate to the user that the data has been manipulated. The automatic encryption depending on the classification of the data carrier as well as the defined strategy is not visible to the user, since the encryption during the storing of the data on the data carrier as well as the decryption during reading of data from the data carrier is effected automatically and since this process is carried out in the kernel mode, i.e. is not visible to the user. Thereby, in particular theft of data by such persons that indeed have the right to manage data, but however have no right of transferring data, is avoided. The method can be applied without knowledge of the user.

Further details of the illustrated embodiment can be seen in FIG. 4.

The classifier 114 controls some or all interfaces and bus systems on which a possibility of connecting a data carrier 104 exists. The classifier 114 can differentiate between data carriers 104 and other devices such as keyboard, mouse, printer, scanner, etc.

Data carriers 104 (volumes) that have been recognized are classified regarding their “hazard potential”. For the classification, the declared properties, contents as well as the embedding in the operating system, are being analyzed.

Thus, for example the volume on which the operating system is installed is classified in a manner that is different from that of a volume that is subsequently mounted via a USB port on a memory stick; a floppy disk is classified differently from a hard disk.

It is particularly advantageous that no determined volume is selected for encryption but rather a class of volumes that can contain an arbitrary number of instances. The classification is based on the type, content and behavior of each volume. Thus, in the method according to the invention, the full functionality of the interfaces is maintained, for example when a printer is connected to a USB port.

The activity terminal 113 observes the communication of the file system drivers with the remaining components. It records requests (read/write/seek/ioctl/ . . . ) from the user mode 200, for example from services or application programs as well as requests from the kernel mode 100, for example from the cache manager 101 or the memory manager 102. The analysis of the communication enables the formation of two disjunctive classes, i.e. any request can be definitely assigned.

These are:

1. Data transfer and function within the central memory,

2. Data transfer and functions by means of a data carrier 104.

All requirements of the second class must pass the encryption/decryption module 105 and are there manipulated according to the embedded strategy. They are provided with a virtual label whose information is important for the decision of the encryption or decryption module 105 how to process the data of the request.

Requests that are carried out directly, i.e. without the data carrier 104, for example by or by means of the cache can pass without being modified.

By performing the encryption or decryption only during the relatively slow accesses to the data carrier 104, this design reduces the impact on the system performance to an absolute minimum. The encryption or decryption as well is carried out with maximum efficiency, since practically at any time, blocks of the same size are being processed and the algorithm can be optimized accordingly.

By means of the key manager 116, one or more keys for the encryption and decryption 105 are provided.

FIG. 5 shows the modification of a file 50 that is to be stored on a storage medium 104 by the encryption 105 via utilization of a prefix 601 or a suffix 603, i.e. that the file 60 that in fact is stored on the storage medium 104 is modified in comparison to the file 50 of the client of the file system 103. The client of the file system 103 in particular is any application program as well as any component of the operating system that uses the services of the file system, such as for example reading and writing of files.

When a private prefix 601 or suffix 603 (i.e. that is only used in the foregoing method) in an encrypted file 60, the size of the additional data is detracted from the file sizes. A file 502 that is accordingly smaller is “displayed” to the client of the file system 103.

When a private prefix 601 is used in an encrypted file 60, the position information is transformed by means of additions/subtractions. The position that is supposed to be the beginning of the file for the client of the file system 103 in the file 50 is physically the position on the data carrier 104 that is directly after the private prefix 601.

The use of a private suffix 603 similarly cannot be seen by the client of the file system 103. The supposed end of the file is the beginning of the suffix 603 on the data carrier 104 (which the client of the file system 103 cannot access).

The client of the file system 103 thus can only see the file name 500 as well as the actual files 502 can be seen that are also visible to the user in this form. The real, i.e. physical file 60 on the storage medium 104 nevertheless has a modified file name 600. Furthermore, the content, i.e. the file 602 itself is modified, independent of its inner structure, compared to the file content 502 that is seen by the client of the file system 103 and a prefix 601 and/or a suffix 603 is added thereto.

For encrypted files 60, for all operations regarding file names 600, a name-space transformation is carried out.

For encrypted files 60, the decryption 105 is carried out. In the case of a missing or incorrect key, a message is provided; access is refused as in systems that do not work with this method, i.e. missing keys already lead to the messages in the activity terminal. The request does not reach the file system driver.

For files 50 that are to be encrypted, encryption 105 is carried out.

When keys are missing, no writing operation is possible, i.e. in this case as well, missing keys already lead to messages in the activity terminal and do not reach the file system driver.

All other data (files not be encrypted, meta-data of the file system except of if necessary file sizes) are not modified. The specific advantages of each file system 103 are fully maintained.

For the encryption 105, a stream encryption as well as a block encryption can be applied. Since block based methods generally provide better results and since nearly all data is already present in blocks of constant size, its use is recommended.

A flowchart showing the process of opening or generating a file by applying the method according to the invention is shown in FIG. 6, where a temporary suspension of the encryption is permitted. The authorization as well as the key is checked. When the conditions are fulfilled, a “normal” operation mode is run. If one of the conditions is not fulfilled, this leads to an error message, i.e. the data is hidden to the user.

In the FIGS. 7 and 8, the data stream during reading and writing of a file by means of the method according to the invention according to FIG. 4 is represented with respect to a memory manager 102 as well as a cache manager 101 (in FIG. 7) or without respect to a memory manager and of a cache manager (in FIG. 8). In FIG. 9, the data stream during reading and writing via Memory Mapped Files MMF is represented.

In the FIGS. 7 to 9, it can be seen that access to the storage medium 104 taking into account the classifier 114 due to the implementation of the method in the kernel mode 100 is only possible taking into account the encryption or decryption module 105. Access to storage medium 104 without passing the encryption or decryption module 105 is securely avoided.

Independently of whether or what form of memory manager 102 and a cache manager 101 are implemented in the kernel mode 100 of the operating system and involved in the interaction with the file system 103, there is monitoring of the data stream 130, 131 between file system 103 and storage medium 104 by means of the activity terminal and the encryption 105, where the storage medium 104 is classified due to the classifier 114 with respect to the potential risk of the loss of the confidentiality of data. Here the data stream 130 from the file system 103 to the storage medium 104 is monitored and encrypted according to the established classification, and the data stream 131 from the storage medium 104 to the file system 103 is being monitored, an automatic decryption of the data being carried out.

In FIG. 10, a possibility of forming a key 300 composed of the part designing the domain 301, the individual part 302 as well as a function 303 is represented. All keys 300 are composed of several parts 301, 302, 303 of variable bit length. The domain part 301 is the same for all keys of a domain and generates the initializing vector 4010. It assures the separation of the security domains. Its length should not be less than 128 bits. All computers that function with the proposed method of security domains 10. Data transfer by means of exchangeable media 104 is only possible within a security domain 10.

The individual part 302 in connection with the functional part 303 serves for generating keys of the same type within a security domain. Keys 300 resulting in the same initializing vectors 4010, 4020 with the functional part 303 still being the same, are equivalent. By intelligent selection of the individual part 302, for example by means of a configuration program, key groups and hierarchies can be defined.

The functional part 303 encrypts the function of the key 300 as cryptographic key, authorization key, complement, etc. An order n complement means that these n keys are only effective when used together.

The individual part 302 serves for distinguishing between the individual keys 300 and, if necessary, creating the usage list of the same.

The key manager 116 obtains the keys 300 or individual parts 301, 302, 303 according to different ways:

from the user registration (explicitly modified for this purpose or transitively according to the registered user)

and/or biometrically

and/or from a hardware token

and/or from a key server.

By comparison to predefined profiles, keys 300 can be modified temporarily or permanently. For example, the key 300 that is stored in a lost token can be identified and permanently deactivated due to its individual part 302.

By means of time control, a further differentiation can be effected and particular functions can be limited to defined periods, i.e. regarding a maximum usage time and/or regarding authorized access times.

Alternatively to the representation according to FIG. 10, the key 300 can have a domain part 301, the individual part 302 and/or the function 303 having a length of zero.

The existence of an authorization key enables a user to suspend the encryption 105. If a suitable key exists, data that has already been encrypted is decrypted again, actualizations are effected in an encrypted manner, but newly created files are optionally not encrypted. According to the administrative configuration, further conditions have to be met, such as for example complementary key, determined computer, data/day of the week/time, etc.

The encryption/decryption module 105 is situated in the communication path between the driver for the file system 103 and the driver for the respective data carrier 104. It provides the encryption and decryption according to the implemented strategy and transforms all necessary parameters and results in the communication such that the basic data carrier, though encrypted entirely or partially or otherwise modified is shown correct for the file system 103 according to its specification. It practically creates a virtual data carrier on-the-fly (=transparently) and thus replaces the real data carrier 104. Within a security domain 10, application of the method cannot be noticed.

As encryption algorithm, advantageously the Rijndael algorithm AES can be used. A significant increase of security is achieved due to the use of a combination of a first cryptographic algorithm, 401, for example of the Rijndael algorithm AES with a second, subsequent cryptographic algorithm 402. The security thus increases considerably, since already randomized data serves as input value for the subsequent algorithm. Thus, the difficulty of statistical cryptoanalysis is multiplied.

The positioning of the encryption or decryption on the determined place before or after all processing of data by the file system driver offers further advantages:

The encryption generates data that subsequently do no longer permit a subsequent data compression. A foregoing data compression by the file system driver (e. g. NTFS) is not affected.

Meta data as e.g. the directory of the occupied/free blocks remain—according to the strategy—or all or at least for computers that works according to the above-described method remains unencrypted. Thus, the possibilities of diagnosis and repairing are maintained.

The block structure of the data carriers correlates with the data structure of the more capable, block-oriented cryptographic methods.

It is still fully compatible to Memory Mapped Files. MMFs are a very efficient method of the file access. In the virtual address space of a process, a file is shown in an area (entirely or partially). When an address of this area is being accessed, a site error is caused and the area is placed in the working memory that is filled with blocks from the file. In the case of a modification, modified blocks are being rewritten automatically into the file either directly after explicit request or with a delay in time.

The load of the system performance is reduced to a minimum. The encryption and decryption only takes places at times during which otherwise non used processor time is available (wait for i/o) of data carriers.

Furthermore, the encryption/decryption module implements the desired strategy. There is the possibility of encryption the data carrier in total, i.e. each block is being encrypted or the encryption of all files or the encryption of all several files.

1. A method of preventing the loss of confidentiality of electronically stored data in a computer system, which data in particular is organized as a data system and or subdivided into blocks, in particular with use of exchangeable and/or removable data carriers and/or storage medium, where in particular peripherals are connectable to the computer system, characterized by the following steps:
analysis of the protocol and of the data stream from and to data carriers and/or storage media and/or peripheral devices;
establishment of a classification, in particular for differentiation between nonremovable and removable data carriers and/or storage media;
determination on the basis of the established classification, whether an encryption of the electronically stored data is required for preventing the loss of confidentiality of the data and, depending on this determination, possibly
adding a cryptographic encryption to the data system on a removable data carrier and/or a removable storage medium, or performing a cryptographic encryption on all or several blocks of the removable data carrier and/or of the removable storage medium.

2. The method according to claim 1, further comprising the step of
determining that an encryption of all blocks of the data carrier/storage medium or an encryption of all files before storage on the data carrier/storage medium and that an encryption of several files before storage on the data carrier/storage medium is carried out.

3. The method according to claim 1 wherein a cryptographic encryption is added to each data system on nonremovable or nonexchangeable data carriers or storage media.

4. The method according to claim 3 wherein the cryptographic encryption is temporarily suspended when particular features are shown.

5. The method according to claim 1 wherein when a data carrier or a storage medium without data system is used, an encryption of all blocks is carried out and access is prevented.

6. The method according to claim 1 wherein an encryption is performed when removable data carriers and or removable storage media are used.

7. The method according to claim 1 wherein an encryption is performed when removable data carriers or nonremovable storage media, or network based data carriers or network based storage media are used.

8. The method according to claim 1 wherein when a data carrier or a storage medium is connected to a multifunctional interface or a multifunctional bus, the functionality of the interfaces or the buses is maintained and an encryption is only performed on data streams that are further transmitted to the interface or the bus for storing the data.

9. The method according to claim 1, further comprising the steps of
performing an analysis of the interface or the bus to which a data stream shall be transmitted and
taking the analysis into account for establishing the classification on the basis of the physical connection or the properties of the devices.

10. The method according to claim 1 wherein cryptographic methods for encryption are applied.

11. The method according to claim 1 wherein the encryption is performed in accordance with a first cryptographic method, and thereafter is again encrypted by means of a second cryptographic method.

12. The method according to claim 1, further comprising the step of, during a reading process from a data carrier or storage medium that is at least partially encrypted,
performing a decryption of the data.

13. The method according to claim 1, further comprising the step of
preventing encryption of the data by using hardware with an integrated key or by using a password or by recognizing and controlling biometric data of a user.

14. The method according to claim 13, further comprising the step of
preventing the encryption only at predetermined times.

15. The method according to claim 1 wherein for the encryption, keys are used that are formed by combination of different parts, whereby in particular several computer systems can be combined in groups, the keys of a group of computer systems having a common part as well as a respective individual part.

16. The method according to claim 15 wherein the key that is to be applied for the encryption and decryption can be determined or stored in a data base for being requested or is integrated in a hardware or is determined from biometric data of a user by using an algorithm.

17. The method according to claim 1 wherein actions that are performed by means of the computer system are recorded.

18. The method according to claim 1 wherein the computer system has an operating system that at least distinguishes between a kernel mode and a user mode, the method being at least partially implemented in the kernel mode.

19. The method according to claim 1 wherein a logic combination of several computer systems within a group is performed, wherein within the group the cryptographic encryption is mutually suspended, wherein the cryptographic encryption is maintained with respect to external sources.

20. The method according to claim 1 wherein during access on a data carrier or storage medium, it is determined whether an encryption of all blocks of the data carrier/storage medium or an encryption of all files on the data carrier/storage medium or an encryption of several files is present, and that an encryption of the requested data is performed.
